(19) United States
(12) Patent Application Publication
(10) Pub. No.: US 2023/0122399 A1
(43) Pub. Date: Apr. 20, 2023

(54) MACHINE LEARNING TECHNIQUES FOR PERFORMING OPTIMIZED SCHEDULING OPERATIONS

(71) Applicant: Optum, Inc., Minnetonka, MN (US)

(72) Inventors: Ramprasad Anandam Gaddam, Mumbai (IN); Gregory J. Boss, Saginaw, MI (US); Adam Russell, Arlington, MA (US); Vijay S. Nori, Roswell, GA (US)

(21) Appl. No.: 17/651,872

(22) Filed: Feb. 21, 2022

Related U.S. Application Data
(60) Provisional application No. 63/262,582, filed on Oct. 15, 2021.

(51) Int. Cl. G06Q 10/06

(52) U.S. Cl. CPC G06Q 10/063116; G06N 20/00

(57) ABSTRACT

There is a need for more accurate and more efficient optimized scheduling operations. This need can be addressed by, for example, techniques for performing one or more optimized scheduling operations. In one example, a method includes: determining, using an optimal event time prediction learning machine model, a predicted interactivity measure for an event data object; determining, based at least in part on the predicted interactivity measure and using an optimal event time prediction machine learning model, an optimal event time modification value for the event data object; and determining, by one or more processors, an optimized appointment prediction based at least in part on optimal event time modification value.

### CROSS-REFERENCE TO RELATED APPLICATIONS

This application claims priority to U.S. Provisional Application No. 63/262,582, filed Oct. 15, 2021, the contents of which are hereby incorporated herein in its entirety by reference.

### BACKGROUND

Various embodiments of the present invention address technical challenges related to generating optimized appointment predictions and performing optimized scheduling operations and disclose innovative techniques for improving efficiency and/or reliability of optimized appointment prediction systems.

### BRIEF SUMMARY

In general, embodiments of the present invention provide methods, apparatuses, systems, computing devices, computing entities, and/or the like for performing optimized scheduling operations. Various embodiments of the present invention disclose techniques for generating optimized appointment predictions that can be used to determine recommended parameters and performing optimized scheduling operations.

In accordance with one aspect, a computer-implemented method for performing one or more optimized scheduling operations with respect to an event data object is provided. In one embodiment, the computer-implemented method comprises: identifying, by one or more processors, a base time period and an upper bound extension time period (which may be a positive or a negative value) for the event data object, determining, by the one or more processors, a predicted interactivity measure for the event data object, determining, by the one or more processors and using an optimal event time prediction machine learning model, an optimal event time modification value for the event data object, wherein the optimal event time prediction machine learning model is configured to generate the optimal event time modification value based at least in part on the base time period, the upper bound extension time period, and the predicted interactivity measure, determining, by one or more processors, an optimized appointment prediction based at least in part on the optimal event time modification value, and performing, by the one or more processors, the one or more optimized scheduling operations based at least in part on the optimized appointment prediction.

In accordance with another aspect, an apparatus for performing one or more optimized scheduling operations with respect to an event data object is provided, the apparatus comprising at least one processor and at least one memory including program code, the at least one memory and the program code configured to, with the processor, cause the apparatus to at least: identify a base time period and an upper bound extension time period for the event data object, determine a predicted interactivity measure for the event data object, determine, using an optimal event time prediction machine learning model, an optimal event time modification value for the event data object, wherein the optimal event time prediction machine learning model is configured to generate the optimal event time modification value based at least in part on the base time period, the upper bound extension time period, and the predicted interactivity measure, determine an optimized appointment prediction based at least in part on the optimal event time modification value, and perform the one or more optimized scheduling operations based at least in part on the optimized appointment prediction.

In accordance with yet another aspect, a computer program product for performing one or more optimized scheduling operations with respect to an event data object is provided, the computer program product comprising at least one non-transitory computer-readable storage medium having computer-readable program code portions stored therein, the computer-readable program code portions configured to: identify a base time period and an upper bound extension time period for the event data object, determine a predicted interactivity measure for the event data object, determine, using an optimal event time prediction machine learning model, an optimal event time modification value for the event data object, wherein the optimal event time prediction machine learning model is configured to generate the optimal event time modification value based at least in part on the base time period, the upper bound extension time period, and the predicted interactivity measure, determine an optimized appointment prediction based at least in part on the optimal event time modification value, and perform the one or more optimized scheduling operations based at least in part on the optimized appointment prediction.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system architecture that can be used to practice embodiments of the present invention.

FIG. 2 provides an example optimized appointment prediction computing entity in accordance with some embodiments discussed herein.

FIG. 3 provides an example client computing entity in accordance with some embodiments discussed herein.

FIG. 4 provides an exemplary schematic of a system architecture for generating an optimal event time modification value that can be used to generate optimized appointment predictions in accordance with some embodiments discussed herein.

FIG. 5 provides a flowchart diagram illustrating an example process for generating an optimized appointment prediction and performing one or more optimized scheduling operations in accordance with some embodiments discussed herein.

FIG. 6 provides a flowchart diagram illustrating an example process for determining a predicted interactivity measure in accordance with some embodiments discussed herein.

FIG. 7 provides a flowchart diagram illustrating an example process for determining a recipient verbal explanation measure in accordance with some embodiments discussed herein.

FIG. 8 provides a flowchart diagram illustrating an example process for determining a provider verbal explanation measure in accordance with some embodiments discussed herein.

FIG. 9A-9B provide operational examples of determining an optimal event time modification value in accordance with some embodiments discussed herein.

FIG. 10 provides an operational example of data prediction output user interface in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. OVERVIEW AND TECHNOLOGICAL ADVANTAGES

Various embodiments of the present invention address technical challenges related to reducing operational load of event scheduling systems and improving computational efficiency of the noted event scheduling systems. For example, as described herein, various embodiments of the present invention enable optimized appointment time predictions that allocate optimized appointment times based at least in part on predicted interaction scores for proposed appointments/interactions, which in turn reduces the need for scheduling follow-up appointments, thus reducing operational load of event scheduling systems and improving computational efficiency of the noted event scheduling systems.

Various embodiments of the present invention disclose techniques for generating optimized appointment predictions and performing optimized scheduling operations that dynamically adjust to changes in various conditions and parameters to improve the accuracy and reliability of generated predictions. In general, optimizing scheduling operations in relation to patient and provider interactions are beneficial for better health outcomes.

Known appointment scheduling systems are not configured to dynamically schedule appointments based at least in part on predictive outputs. Currently, provider appointments are blocked in fixed time slots, e.g., 15 minutes per patient. However there may be significant variance in the number of words and the amount of time utilized to convey the same information about an issue, symptom or concept by a particular patient, his or her associate and/or a particular provider. For example, person A may take 2 minutes to explain X symptoms, while person B may take 15 minutes to explain the same symptoms.

There is a need for improved systems and methods configured to perform optimized scheduling operations. Accordingly, various embodiments of the disclosed techniques improve accuracy and reliability of optimized appointment prediction systems and predictive data analysis relative to various state-of-the-art solutions.

Various embodiments of the present invention generate optimized appointment predictions that can be used to generate recommended parameters for performing scheduling operations. Using the methods described herein, the resulting optimized appointment prediction data outputs/objects lead to more accurate predictions which can be used to perform optimized scheduling operations and generate user interface data for an end user. Accordingly, using some or all of the innovative techniques disclosed herein for performing optimized appointment prediction operations, various embodiments of the present invention increase accuracy of appointment related parameter predictions. In doing so, various embodiments of the present invention make substantial technical contributions to the field of predictive data analysis and substantially improve state-of-the-art optimized appointment prediction systems.

### II. DEFINITIONS OF CERTAIN TERMS

The term “event data object” may refer to a data object storing and/or providing access to information/data with respect to a scheduled event. In some embodiments, an event data object may describe one or more recorded events (e.g., a recorded event that is associated with a recipient profile and a provider profile). By way of example, an event data object may describe or otherwise be associated with a medical encounter, medical appointment, medical procedure, medical visit, and/or the like. In some embodiments, an event data object may comprise audio data, a transcript, video sensor data, combinations thereof, and/or the like.

The term “predicted interactivity measure” may refer to a data object that describes a predictive output, wherein the predictive output is a value describing an inferred determination relating to how effectively two actors/agents (e.g., a recipient entity and a provider entity) are likely to communicate with one another during a prospective event or interaction. In some embodiments, determining the predicted interactivity measure may comprise identifying a recipient profile and a provider profile for an event data object. In some embodiments, the predicted interactivity measure may be an output of an optimal event time prediction machine learning model. Additionally, in some embodiments, determining the predicted interactivity measure may comprise determining a recipient verbal explanation measure and recipient understanding measure for the recipient profile, determining a provider verbal explanation measure and provider understanding measure for the provider profile, and determining the predicted interactivity measure based at least in part on the recipient verbal explanation measure, the recipient understanding measure, the provider verbal explanation measure and the provider understanding measure. In some examples, the predicted interactivity measure may be a value (e.g., a percentage value or a number between 0 and 1), where an above-threshold value indicates that the two entities (e.g., a recipient entity and a provider entity) are likely to communicate with one another effectively during a prospective event or interaction. In other examples, a median value may indicate that the two entities are likely to communicate with one another effectively during a prospective event or interaction.

The term “optimal event time prediction machine learning model” may refer to a data object that describes steps/operations, hyper-parameters, and/or parameters of a machine learning model that is configured to determine an optimal event time modification value with respect to a prospective event or interaction between two entities. The steps/operations of the optimal event time prediction machine learning model may lead to performing one or more optimized scheduling operations. The optimal event time prediction machine learning model may be configured to determine, based at least in part on a predicted interactivity measure, an upper bound extension time period and a base time period, an optimal event time modification value. In some embodiments, the optimal event time prediction machine learning model comprises a first sub-model that is configured to determine the predicted interactivity measure. Additionally, the optimal event time prediction machine learning model may comprise a second sub-model that is configured to determine the base time period and the upper bound extension time period. In some embodiments, the first sub-model generates an output having a minimal value when the predicted interactivity measure has a medial value. The optimal event time prediction machine learning model may be trained based at least in part on a ground-truth optimal event time modification value. The ground-truth optimal event time modification value may be a data object describing a subset of event data objects and ground-truth event time modification values associated therewith. An example of an optimal event time prediction machine learning model is a survival machine learning model, a convolutional neural network model, and/or the like. In some examples, the optimal event time modification value may be determined based at least in part on the following equation:

O=(1−2*I)*(X+M)

In the above equation:

O is the optimal event time modification value;

I is the predicted interactivity measure;

X is the base time period; and

M is the upper bound extension period.

In some embodiments, the optimal event time period machine learning model is configured to generate an output having a minimal value when the predicted interactivity measure has a medial value (e.g., a midrange of a total range of the predicted interactivity measure, for example the medial value of 0.5 for the range [0, 1]). For example, if the base time period is 30 minutes, the upper bound extension period is 10 minutes and the predicted interactivity measure is a medial value of 0.5, then the optimal event time modification value is 0.

The term “optimized appointment prediction” may refer to a data object that describes a predictive output of one or more computer-implemented processes, wherein the predictive output describes one or more predictive inferences relating to an event data object. For example, an optimized appointment prediction may relate to a prospective event or interaction associated with a recipient profile and a provider profile.

The term “base time period” may refer to a data object that describes a predefined/preset time period that is associated with a prospective event or interaction. For example, the base time period may be a predetermined or default time period for a type of prospective event or interaction (e.g., medical encounter or medical procedure). By way of example, a base time period for a psychiatric therapy session may be 60 minutes. In another example, a base time period for a physiotherapist session may be 30 minutes. In yet another example, a base time period for a discharge advise interaction may be 10 minutes. In some embodiments, the base time period may be an output of a sub-model of an optimal event time prediction machine learning model.

The term “optimal event time modification value” may refer to a data object that describes a inferred optimal value/prospective value for modifying (e.g., extending or reducing) a base time period. In some embodiments, the optimal event time modification value may not exceed an upper bound extension period defining a maximum value that can be added to the base time period. The optimal event time modification value may be a predictive output of a sub-model of an optimal event time prediction machine learning model and may be determined based at least in part on a base time period, an upper bound extension time period and a predicted interactivity measure that are associated with an event data object.

The term “upper bound extension period” may refer to a data object that describes an upper limit associated with an optimal event time modification value. For example, the upper bound extension period may define a maximum value that can be added to a base time period. In some embodiments, the upper bound extension period may be an output of a sub-model of an optimal event time prediction machine learning model.

The term “threshold deviation measure” may refer to a data object that describes a threshold value which, when exceeded by an optimal event time modification value, triggers one or more additional steps/operations in order to improve or refine the predictive output. For example, the threshold deviation measure may trigger a request for secondary analysis with respect to an event data object. The threshold deviation measure may be associated with/based at least in part on the maximum value of the upper bound extension period.

The term “recipient verbal explanation measure” or “provider verbal explanation measure” may refer to a predictive output of one or more computer-implemented processes, wherein the predictive output describes an inferred determination about a recipient entity or provider entity's ability to effectively communicate verbally. The verbal explanation measure may be based at least in part on analysis of one or more event data objects (e.g., comprising audio data, a transcript, video sensor data, and/or the like). Additionally, an example recipient verbal explanation measure may be determined based at least in part on known medical conditions associated with the recipient entity or provider entity (e.g., echolalia, stammering, compulsive repeating disorder, or the like). Similarly, by way of example, a provider verbal explanation measure may be determined based at least in part on analysis of historical event data objects that are each associated with a target sub-population associated with one or more target attributes (e.g., age, gender, topic, and/or the like). Further, determining the verbal explanation measure may comprise identifying a nature/type of explanation or topic, word repetition, explanation duplication, consistency in explanation, explanation clarity (e.g., a count of explanations associated with an identified topic), and/or the like. In some examples, the verbal explanation measure may be a value (e.g., a percentage value or a number between 0 and 1), where an above threshold value indicates that the recipient entity or provider entity is able to effectively communicate verbally. In some embodiments, the verbal explanation measure may be determined based at least in part on a verbosity measure and/or an effectiveness measure associated with a particular entity.

The terms “recipient verbosity measure” or “provider verbosity measure” may refer to a data object that describes an inferred determination relating to verbosity or sparsity of speech associated with a recipient entity or provider entity, respectively. In some embodiments, the verbosity measure may be determined based at least in part on a number and/or complexity of words. By way of example, the verbosity measure may be determined based at least in part on a ratio of a number of words to a number of syllables. In some examples, the verbosity measure may be determined based at least in part on the following equation:

$$verbosity measure = 1 - \frac{n umber of words}{n umber of syllables}$$

The terms “recipient effectiveness measure” or “provider effectiveness measure” may refer to a data object that describes an inferred determination relating to effectiveness of speech associated with a recipient entity or a provider entity, respectively. In some embodiments, the effectiveness measure may be determined based at least in part on direct or indirect feedback (e.g., survey data) provided by the communicatee. In some examples, the effectiveness measure may be determined based at least in part on the following equation:

$$effectiveness measure = \frac{count of correct responses to posed questions}{count of posed questions}$$

The terms “recipient understanding measure” or “provider understanding measure” may refer to a predictive output of one or more computer-implemented processes, wherein the predictive output describes an inferred determination about a recipient entity or provider entity's ability to comprehend verbal communication, respectively. In some embodiments, the understanding measure may be based at least in part on a recipient entity or provider entity's responses to posed questions. Additionally, the understanding measure may be based at least in part on identified features such as a count of counter or probing responses, an inferred ability to build on an explanation and/or understand a concept in its entirety, a count of repetition requests, a time period associated with an explanation, and/or the like. In some examples, the understanding measure may be a value (e.g., a percentage value or a number between 0 and 1), where an above threshold value indicates that the recipient entity or provider entity is able to effectively comprehend verbal communication. In some embodiments, the recipient understanding measure is determined based at least in part on one or more accent features describing an accent of the recipient entity. In some embodiments, the provider understanding measure is determined based at least in part on one or more accent features describing an accent of the provider entity.

The term “recipient profile” may refer to a data object storing and/or providing access to information/data for a recipient entity. In some embodiments, a recipient profile may describe a patient. In some examples, the information/data may describe medical information/data and/or historical event data for the recipient entity. In some embodiments, the recipient profile may be utilized to determine or otherwise associated with a recipient verbal explanation measure, a recipient verbosity measure, a recipient understanding measure, and/or the like. In some embodiments, historical medical information/data can include attributes such as age, gender, known health conditions, and/or the like.

The term “provider profile” may refer to a data object storing and/or providing access to information/data for a provider entity. In some embodiments, a provider profile may describe a medical provider. In some examples, the information/data describes medical information/data and/or historical event data for the provider entity. In some embodiments, the recipient profile may be utilized to determine or otherwise associated with a provider verbal explanation measure, a provider verbosity measure, a provider understanding measure, and/or the like.

### III. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. EXEMPLARY SYSTEM ARCHITECTURE

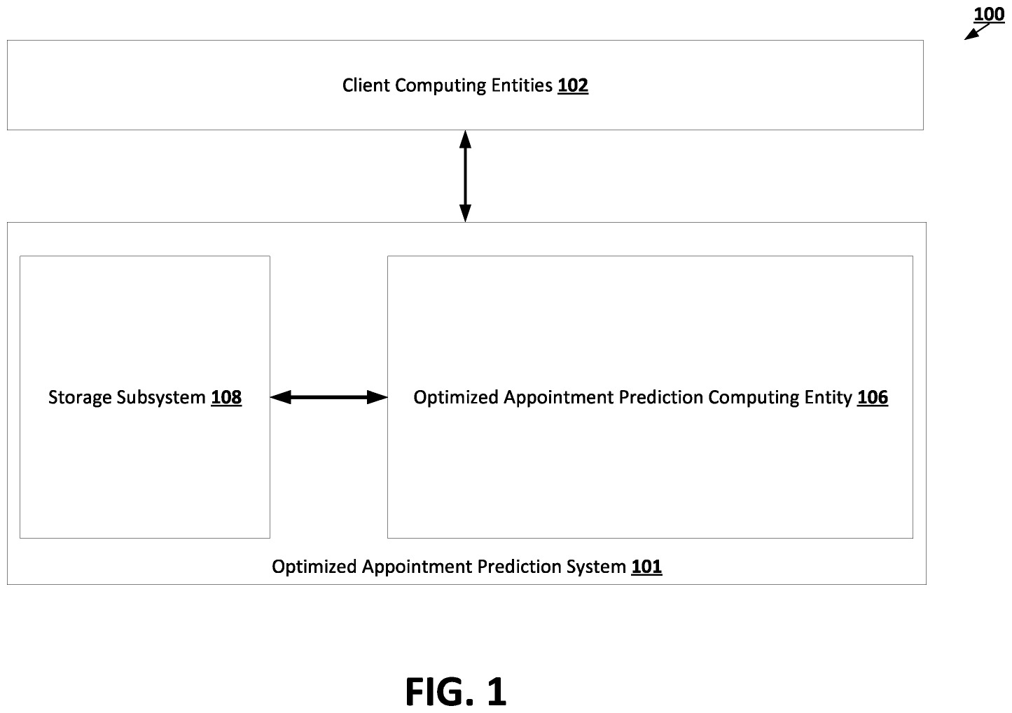

FIG. 1 is a schematic diagram of an example system architecture 100 for performing optimized scheduling operations. The architecture 100 includes an optimized appointment prediction system 101 configured to receive data from the client computing entities 102, process the data to generate predictive outputs (e.g., optimized appointment prediction data objects) and provide the outputs to the client computing entities 102 for generating user interface data and/or dynamically updating a user interface. In some embodiments, optimized appointment prediction system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The optimized appointment prediction system 101 may include an optimized appointment prediction computing entity 106 and a storage subsystem 108. The optimized appointment prediction computing entity 106 may be configured to receive queries, requests and/or data from client computing entities 102, process the queries, requests and/or data to generate predictive outputs, and provide (e.g., transmit, send and/or the like) the predictive outputs to the client computing entities 102. The client computing entities 102 may be configured to transmit requests to the optimized appointment prediction computing entity 106 in response to queries. Responsive to receiving the predictive outputs, the client computing entities 102 may generate user interface data and may provide (e.g., transmit, send and/or the like) user interface data for presentation by user computing entities.

The storage subsystem 108 may be configured to store at least a portion of the data utilized by the optimized appointment prediction computing entity 106 to perform optimized scheduling operations and tasks. The storage subsystem 108 may be configured to store at least a portion of operational data and/or operational configuration data including operational instructions and parameters utilized by the optimized appointment prediction computing entity 106 to perform optimized scheduling operations in response to requests. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Optimized Appointment Prediction Computing Entity

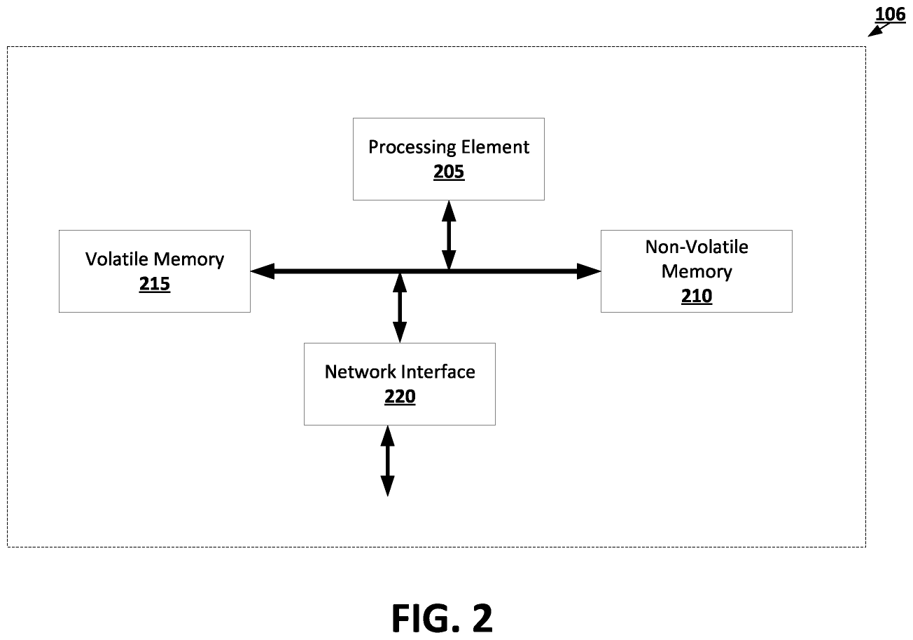

FIG. 2 provides a schematic of an optimized appointment prediction computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the optimized appointment prediction computing entity 106 may also include one or more network interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the optimized appointment prediction computing entity 106 may include or be in communication with one or more processing elements 205 (also referred to as processors, processing circuitry, and/or similar terms used herein interchangeably) that communicate with other elements within the optimized appointment prediction computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the optimized appointment prediction computing entity 106 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the optimized appointment prediction computing entity 106 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the optimized appointment prediction computing entity 106 with the assistance of the processing element 205 and operating system.

As indicated, in one embodiment, the optimized appointment prediction computing entity 106 may also include one or more network interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the optimized appointment prediction computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the optimized appointment prediction computing entity 106 may include or be in communication with one or more input elements, such as a keyboard input, a mouse input, a touch screen/display input, motion input, movement input, audio input, pointing device input, joystick input, keypad input, and/or the like. The optimized appointment prediction computing entity 106 may also include or be in communication with one or more output elements (not shown), such as audio output, video output, screen/display output, motion output, movement output, and/or the like.

### Exemplary Client Computing Entity

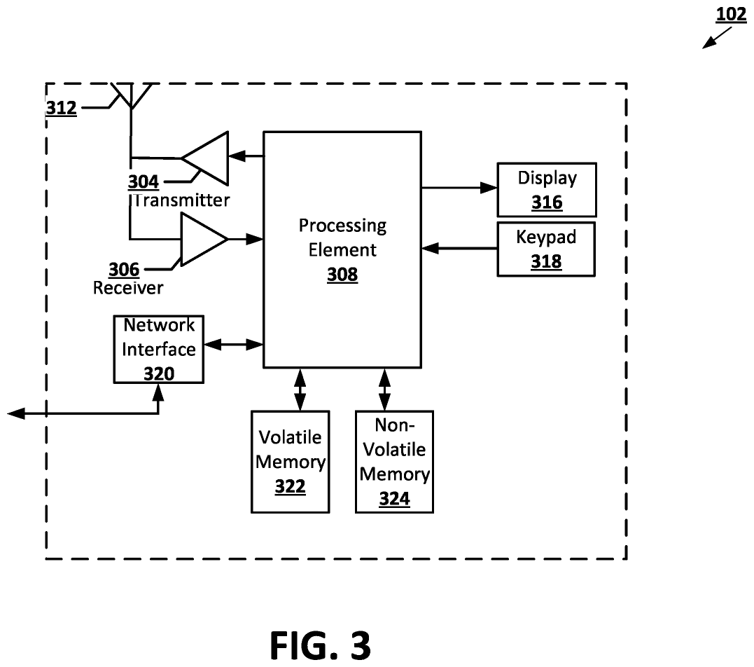

FIG. 3 provides an illustrative schematic representative of a client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the optimized appointment prediction computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the optimized appointment prediction computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the target user profile interface may be a user application, browser, user interface, and/or similar words used herein interchangeably executing on and/or accessible via the client computing entity 102 to interact with and/or cause display of information/data from the optimized appointment prediction computing entity 106, as described herein. The target user profile input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the target user profile input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the optimized appointment prediction computing entity 106 and/or various other computing entities.

In another embodiment, the client computing entity 102 may include one or more components or functionality that are the same or similar to those of the optimized appointment prediction computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. EXEMPLARY SYSTEM OPERATIONS

Described herein are various techniques for performing optimized scheduling operations. Some of the described techniques utilize a particular configuration of units and/or steps/operations. However, a person of ordinary skill in the art will recognize that optimized scheduling operations discussed herein may be performed using different combinations than the particular combinations described herein.

By facilitating efficient optimized scheduling operations, various embodiments of the present invention improve accuracy of generated optimized appointment predictions. Performing optimized scheduling operations according to the methods disclosed facilitates dynamic updates in response to up-to-date conditions and parameters. This in turn ensures that available data is utilized to improve system reliability and efficiency.

As described below, various embodiments of the present invention address technical challenges related to reducing operational load of event scheduling systems and improving computational efficiency of the noted event scheduling systems. For example, as described herein, various embodiments of the present invention enable optimized appointment time predictions that allocate optimized appointment times based at least in part on predicted interaction scores for proposed appointments/interactions, which in turn reduces the need for scheduling follow-up appointments, thus reducing operational load of event scheduling systems and improving computational efficiency of the noted event scheduling systems.

### Exemplary Optimized Appointment Prediction System

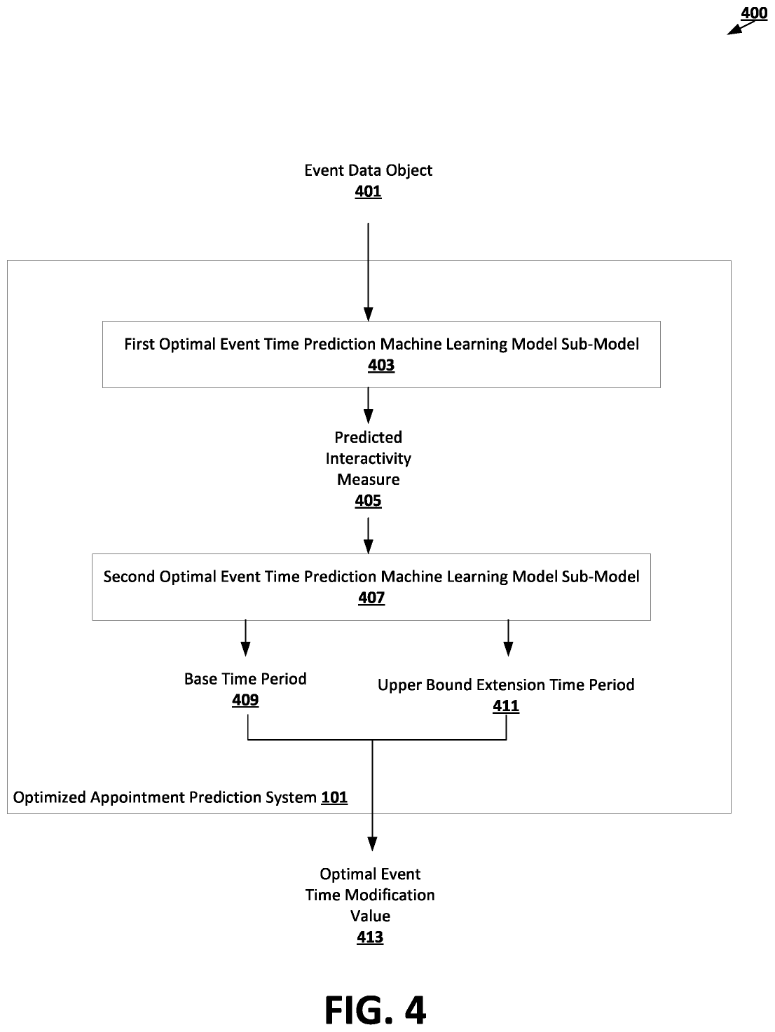

FIG. 4 provides an exemplary optimized appointment prediction system architecture 400. As depicted in FIG. 4, the optimized appointment prediction system 101 is configured to process at least one event data object 401 in order to generate one or more predictive outputs, including an optimal event time modification value 413, that may lead to generating an optimized appointment prediction. The storage subsystem 108 may provide, as input to the optimized appointment prediction computing entity 106, the at least one event data object 401. In some embodiments, the storage subsystem 108 may also provide access to data/information associated with one or more entities/profiles (e.g., a recipient profile and a provider profile). As noted herein, the term event data object may be or comprise a data object storing and/or providing access to information/data with respect to which one or more predictive outputs may be generated. For example, an event data object may describe one or more recorded events between two or more entities. Additionally, an event data object may in turn be associated with one or more entities/profiles (e.g., a recipient profile and a provider profile). An example event data object may describe a medical encounter, medical appointment, medical procedure, and/or the like. In some embodiments, an event data object may comprise audio data, a transcript, video sensor data, combinations thereof, and/or the like. The term optimized appointment prediction may refer to a data object that describes a predictive output of one or more computer-implemented processes, wherein the predictive output describes one or more predictive inferences relating to an event data object. For example, an optimized appointment prediction may relate to a prospective event or interaction associated with a recipient profile and a provider profile.

As further depicted in FIG. 4, the optimized appointment prediction system 101 comprises a first optimal event time prediction machine learning model sub-model 403 that is configured to process the event data object 401 in order to generate a predicted interactivity measure 405. Additionally, as depicted, the optimized appointment prediction system 101 comprises a second optimal event time prediction machine learning model sub-model 407 that is configured to process the event data object 401 and/or the predicted interactivity measure 405 in order to determine a base time period 409 and an upper bound extension time period 411 (as further described below). The optimal event time modification value 413 is generated based at least in part on at least one of the base time period 409 and the upper bound extension time period 411. Once generated, the optimal event time modification value 413 can be used to generate an optimized appointment prediction and perform one or more optimized scheduling operations based at least in part on the optimized appointment prediction, as further described below.

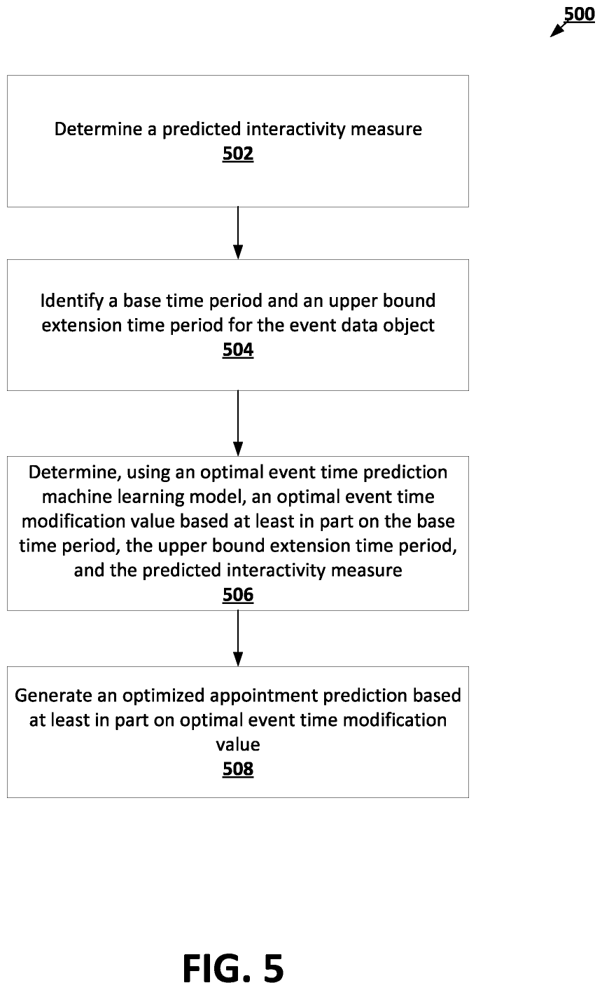

Referring now to FIG. 5, a flowchart diagram illustrating an example process for generating an optimized appointment prediction which can be used to perform one or more optimized scheduling operations in accordance with some embodiments discussed herein is provided.

Beginning at step/operation 502, the optimized appointment prediction system 101 determines a predicted interactivity measure for an event data object. The term predicted interactivity measure may refer to a data object that describes a predictive output, wherein the predictive output is a value describing an inferred determination relating to how effectively two agents/actors (e.g., a recipient entity and a provider entity) are likely to communicate with one another during a prospective event or interaction. In some embodiments, the predicted interactivity measure may be determined based at least in part on contextual information and/or analysis of a plurality of historical interactions associated with a particular recipient entity and/or provider entity.

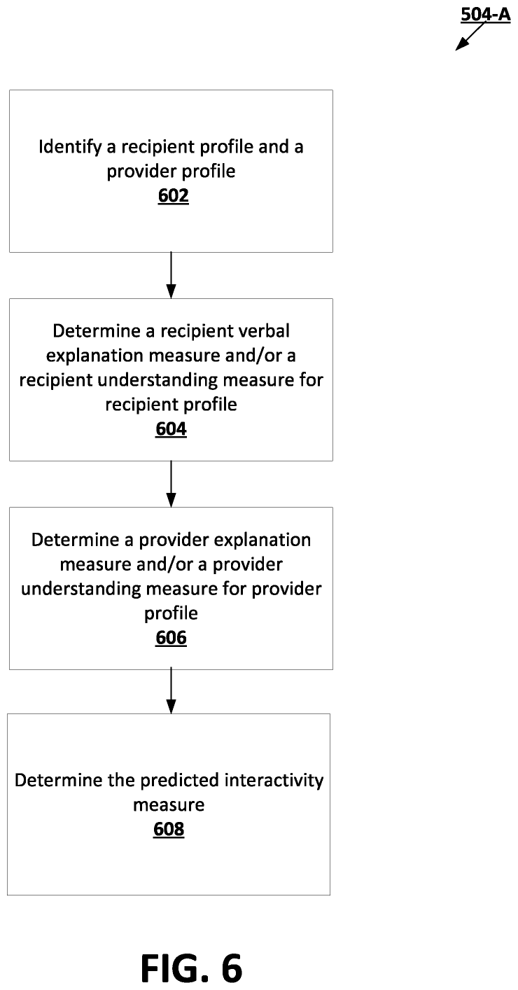

Referring now to FIG. 6, a flowchart diagram illustrating an example process 504-A for determining a predicted interactivity measure in accordance with some embodiments discussed herein is provided.

Beginning at step/operation 602, the optimized appointment prediction system 101 identifies a recipient profile and a provider profile. The term recipient profile may refer to a data object storing and/or providing access to information/data for a recipient entity, e.g., a patient. The recipient profile may comprise medical information/data and/or historical event data for the recipient entity. Additionally, the recipient profile may include attributes such as age, gender, known health conditions, and/or the like. The term provider profile may refer to a data object storing and/or providing access to information/data for a provider entity, e.g., a medical provider. In some embodiments, the provider profile may comprise medical information/data and/or historical event data for the provider entity.

Subsequent to step/operation 602, the process 504-A proceeds to step/operation 604. At step/operation 604, the optimized appointment prediction system 101 determines a recipient verbal explanation measure and/or recipient understanding measure for the recipient profile. The recipient verbal explanation measure may be or comprise a predictive output of one or more computer-implemented processes, wherein the predictive output describes an inferred determination about the recipient entity's ability to effectively communicate verbally. In some embodiments, the recipient verbal explanation measure may be based at least in part on analysis of one or more event data objects (e.g., comprising audio data, a transcript, video sensor data, and/or the like) associated with the recipient entity. Additionally and/or alternatively, the recipient verbal explanation measure may be determined based at least in part on known medical conditions associated with the recipient entity (e.g., echolalia, stammering, compulsive repeating disorder, or the like). Further, determining the recipient verbal explanation measure may comprise identifying a nature/type of explanation or topic, word repetition, explanation duplication, consistency in explanation, explanation clarity (e.g., a count of explanations associated with an identified topic), and/or the like. In some embodiments, the recipient explanation measure score may be a value (e.g., a percentage value or a number between 0 and 1), where an above-threshold value indicates that the recipient entity is able to effectively comprehend verbal communication.

The recipient understanding measure may refer to a data object that describes a predictive output of one or more computer-implemented processes, wherein the predictive output describes an inferred determination about a recipient entity's ability to quickly comprehend verbal communication. In some embodiments, the recipient understanding measure may be based at least in part on the recipient entity's response(s) to one or more posed questions. Additionally, the recipient understanding measure may be based at least in part on identified features such as a count of counter or probing responses, an inferred ability to build on an explanation and/or understand a concept in its entirety, a count of repetition requests, a time period associated with an explanation, and/or the like. In some embodiments, the recipient understanding measure may be a value (e.g., a percentage value or a number between 0 and 1), where an above threshold value indicates that the recipient entity is able to effectively comprehend verbal communication.

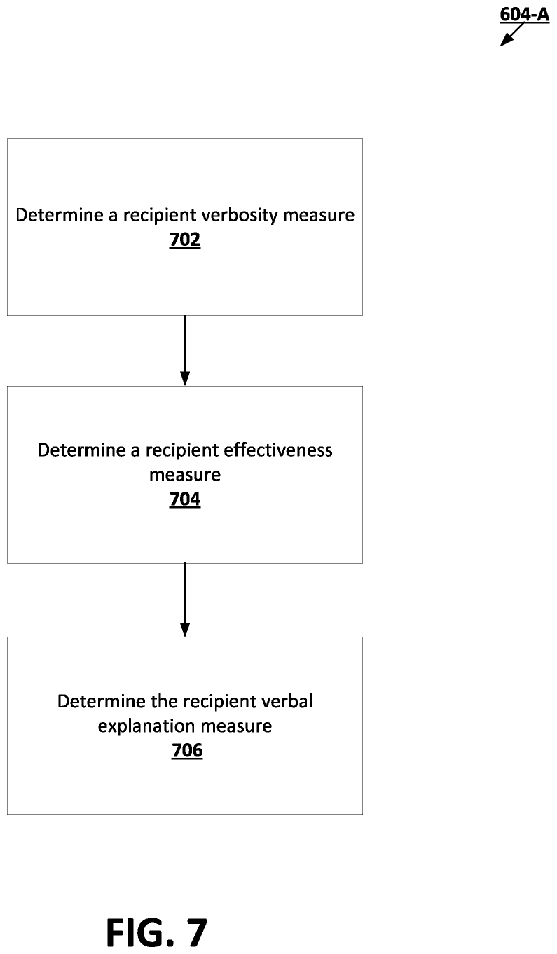

Referring now to FIG. 7, a flowchart diagram illustrating an example process 604-A for determining a recipient verbal explanation measure in accordance with some embodiments discussed herein is provided.

Beginning at step/operation 702, the optimized appointment prediction system 101 determines a recipient verbosity measure for a recipient profile. The recipient verbosity measure may refer to a data object that describes an inferred determination relating to verbosity or sparsity of speech associated with a recipient entity. In some embodiments, the recipient verbosity measure may be determined based at least in part on a number and/or complexity of words. In some embodiments, the recipient verbosity measure may be determined based at least in part on a ratio of a number of words to a number of syllables. In some embodiments, the recipient verbosity measure may be a value (e.g., a percentage value or a number between 0 and 1), where a median value indicates that the recipient entity's speech is optimal (e.g., not overly verbose or overly sparse).

Subsequent to step/operation 702, the process 604-A proceeds to step/operation 704. At step/operation 704, the optimized appointment prediction system 101 determines a recipient effectiveness measure for the recipient profile. The recipient effectiveness measure may refer to a data object that describes an inferred determination relating to effectiveness of speech associated with a recipient entity. In some embodiments, the recipient effectiveness measure may be determined based at least in part on direct or indirect feedback (e.g., survey data) provided by the provider entity. In some embodiments, the recipient effectiveness measure may be a value (e.g., a percentage value or a number between 0 and 1), where an above-threshold threshold value indicates that the provider entity perceives the recipient entity's communication to be effective.

Subsequent to step/operation 704, the process 604-A proceeds to step/operation 706. At step/operation 706, the optimized appointment prediction system 101 determines the recipient verbal explanation measure based at least in part on the recipient verbosity measure and the recipient effectiveness measure. In some embodiments, the recipient verbal explanation measure may be a value (e.g., a percentage value or a number between 0 and 1), where an above-threshold value indicates that the recipient entity is able to effectively communicate verbally.

Returning to FIG. 6, subsequent to step/operation 604, the process 504-A proceeds to step/operation 606. At step/operation 606, the optimized appointment prediction system 101 determines a provider verbal explanation measure and/or provider understanding measure for the provider profile. Similar to the recipient verbal explanation measure, the provider verbal explanation measure may be or comprise a predictive output of one or more computer-implemented processes, wherein the predictive output describes an inferred determination about the provider entity's ability to effectively communicate verbally. In some embodiments, the provider verbal explanation measure may be based at least in part on analysis of one or more event data objects (e.g., comprising audio data, a transcript, video sensor data, and/or the like) associated with the provider entity. In some embodiments, the provider verbal explanation measure may be determined based at least in part on analysis of historical event data objects that are each associated with a target sub-population that is associated with one or more target attributes (e.g., age, gender, topic, and/or the like). Additionally and/or alternatively, the provider verbal explanation measure may be determined based at least in part on known medical conditions associated with the provider entity (e.g., echolalia, stammering, compulsive repeating disorder, or the like). Further, determining the provider verbal explanation measure may comprise identifying a nature/type of explanation or topic, word repetition, explanation duplication, consistency in explanation, explanation clarity (e.g., a count of explanations associated with an identified topic), and/or the like.

Similar to the recipient understanding measure, the provider understanding measure may refer to a data object that describes a predictive output of one or more computer-implemented processes, wherein the predictive output describes an inferred determination about a provider entity's ability to quickly comprehend verbal communication. In some embodiments, the provider understanding measure may be based at least in part on the provider entity's response(s) to one or more posed questions. Additionally, the provider understanding measure may be based at least in part on identified features such as a count of counter or probing responses, an inferred ability to build on an explanation and/or understand a concept in its entirety, a count of repetition requests, a time period associated with an explanation, and/or the like. In some embodiments, the provider understanding measure may be a value (e.g., a percentage value or a number between 0 and 1), where an above threshold value indicates that the provider entity is able to effectively comprehend verbal communication.

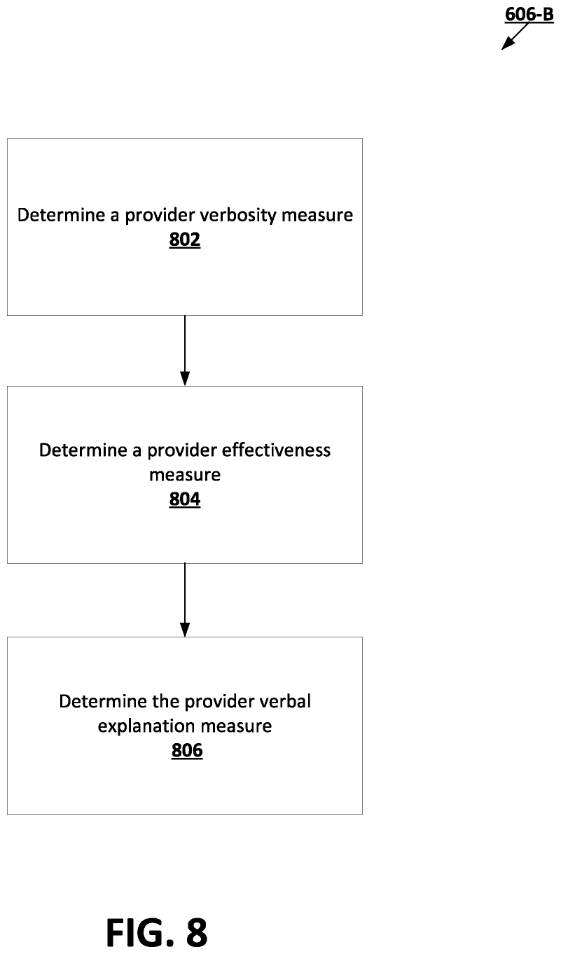

Referring now to FIG. 8, a flow chart diagram illustrating an example process 604-B for determining a provider verbal explanation measure in accordance with some embodiments discussed herein is provided.

Beginning at step/operation 802, the optimized appointment prediction system 101 determines a provider verbosity measure for a provider profile. Similar to the recipient verbosity measure, the provider verbosity measure may refer to a data object that describes an inferred determination relating to verbosity or sparsity of speech associated with a provider entity. In some embodiments, the provider verbosity measure may be determined based at least in part on a number and/or complexity of words. In some embodiments, the provider verbosity measure may be determined based at least in part on a ratio of a number of words to a number of syllables. In some embodiments, the provider verbosity measure may be a value (e.g., a percentage value or a number between 0 and 1), where a median value indicates that the provider entity's speech is optimal (e.g., not overly verbose or overly sparse).

Subsequent to step/operation 802, the process 604-B proceeds to step/operation 804. At step/operation 804, the optimized appointment prediction system 101 determines a provider effectiveness measure for the provider profile. The provider effectiveness measure may refer to a data object that describes an inferred determination relating to effectiveness of speech associated with a provider entity. In some embodiments, the provider effectiveness measure may be determined based at least in part on direct or indirect feedback (e.g., survey data) provided by the recipient entity. In some embodiments, the provider effectiveness measure may be a value (e.g., a percentage value or a number between 0 and 1), where an above-threshold threshold value indicates that the recipient entity perceives the provider entity's communication to be effective.

Subsequent to step/operation 804, the process 604-B proceeds to step/operation 806. At step/operation 806, the optimized appointment prediction system 101 determines the provider verbal explanation measure based at least in part on the provider verbosity measure and the provider effectiveness measure. The provider verbal explanation measure may be a value (e.g., a percentage value or a number between 0 and 1), where an above threshold value indicates that the provider entity is able to effectively communicate verbally. In some embodiments, the provider verbal explanation measure may be a value (e.g., a percentage value or a number between 0 and 1), where an above threshold value indicates that the provider entity is able to effectively communicate verbally.

Returning to FIG. 6, subsequent to step/operation 606, the process 504-A proceeds to step/operation 608. At step/operation 608, the optimized appointment prediction system 101 determines the predicted interactivity measure based at least in part on one of: (i) the recipient verbal explanation measure and/or recipient understanding measure, and (ii) the provider verbal explanation measure and/or provider understanding measure.

Referring back to FIG. 5, at step/operation 504, the optimized appointment prediction system 101 identifies a base time period and an upper bound extension time period for the event data object. The base time period may be a data object that describes a predefined time period that is associated with a prospective event or interaction. For example, the base time period may be a predetermined or default time period for a particular type of prospective event or interaction (e.g., medical encounter or medical procedure). By way of example, a base time period for a psychiatric therapy session may be 60 minutes. In another example, a base time period for a physiotherapist session may be 30 minutes. In yet another example, a base time period for a discharge advise interaction may be 10 minutes.

The upper bound extension period may be a data object that describes an upper limit associated with an optimal event time modification value. For example, the upper bound extension period may define a maximum value that can be added to a base time period. By way of example, an upper bound extension period for a psychiatric therapy session may be 30 minutes. In another example, an upper bound extension period for a physiotherapist session may be 15 minutes. In yet another example, an upper bound extension period for a discharge advise interaction may be 5 minutes. In some embodiments, the optimized appointment prediction system 101 may dynamically and/or periodically adjust the base time period and/or upper bound extension period associated with a prospective event or interaction type based at least in part on analysis historical event data objects describing recorded events.

Subsequent to step/operation 504, the method 500 proceeds to step/operation 506. At step/operation 506, the optimized appointment prediction system 101 determines, utilizing an optimal event time prediction machine learning model, an optimal event time modification value based at least in part on the base time period, the upper bound extension time period and the predicted interactivity measure. The term optimal event time prediction machine learning model may refer to a data object that describes steps/operations and/or parameters of a machine learning model that is configured to determine an optimal event time modification value with respect to a prospective event or interaction between two entities. By way of example, the optimal event time prediction machine learning model may be configured to determine, based at least in part on a predicted interactivity measure, the upper bound extension time period and the base time period, an optimal event time modification value. In various embodiments, the optimal event time prediction machine learning model may comprise one or more components and/or machine learning sub-models that are each configured to perform particular steps/operations. The optimal event time prediction machine learning model may be trained based at least in part on a ground-truth optimal event time modification value. The ground-truth optimal event time modification value may be a data object describing a subset of event data objects and ground-truth event time modification values associated therewith. An example of an optimal event time prediction machine learning model is a survival machine learning model, a convolutional neural network model, and/or the like. In some embodiments, the base time period and the upper bound extension time period may each be outputs of the optimal event time prediction machine learning model.

By way of example, referring to FIG. 4, the optimized appointment prediction system 101 comprises a first optimal event time prediction machine learning model sub-model 403 that is configured to process the event data object 401 in order to generate a predicted interactivity measure 405. Additionally, as depicted, the optimized appointment prediction system 101 comprises a second optimal event time prediction machine learning model sub-model 407 that is configured to process the event data object 401 and/or the predicted interactivity measure 405 in order to determine a base time period 409 and an upper bound extension time period 411.

Returning to FIG. 5, the optimal event time modification value may refer to a data object that describes a inferred optimal value/prospective value for modifying (e.g., extending or reducing) a base time period. In some embodiments, the optimal event time modification value may not exceed an upper bound extension period defining a maximum value that can be added to the base time period. In some embodiments, the optimal event time modification value may be determined based at least in part on the following equation:

O=(1−2*I)*(X+M)

In the above formula:
O is the optimal event time modification value;
I is the predicted interactivity measure;
X is the base time period; and
M is the upper bound extension period.

In some embodiments, the optimal event time period machine learning model is configured to generate an output having a minimal value when the predicted interactivity measure has a medial value. For example, if the base time period is 30 minutes, the upper bound extension period is 10 minutes and the predicted interactivity measure is a medial value of 0.5, then the optimal event time modification value is 0. In some embodiments, the optimized appointment prediction system may trigger one or more additional steps/operations in an instance in which the optimal event time modification value satisfies a threshold deviation measure. The threshold deviation measure may refer to a data object that describes a threshold which, when exceeded by an optimal event time modification value, triggers one or more additional steps/operations. By way of example, the threshold deviation measure may be associated with/based at least in part on the maximum value of the upper bound extension period. In some embodiments, if the optimal event time modification value satisfies the threshold deviation measure, optimized appointment prediction system 101 may perform/trigger a request for secondary analysis with respect to an event data object.

Subsequent to step/operation 506, the method 500 proceeds to step/operation 508. At step/operation 508, the optimized appointment prediction system 101 generates an optimized appointment prediction based at least in part on the optimal event time modification value. As detailed herein, the optimized appointment prediction may describe a predictive inference relating to a prospective event or interaction associated with a recipient profile and a provider profile. By way of example, the optimized appointment prediction may be a prospective appointment time and duration for a recipient entity and a provider entity. For instance, if the base time period for a prospective interaction is 30 minutes and the optimal event time modification value is +10 minutes, then an example optimized appointment prediction may be 40 minutes. In some embodiments, the optimized appointment prediction may further include recommendation of a particular provider entity for a recipient entity (e.g., based at least in part on predicted interactivity measure for the provider entity with respect to a target sub-population that shares one or more target attributes with the recipient entity such as age, gender, topic, and/or the like), recommending an interpreter or the like.

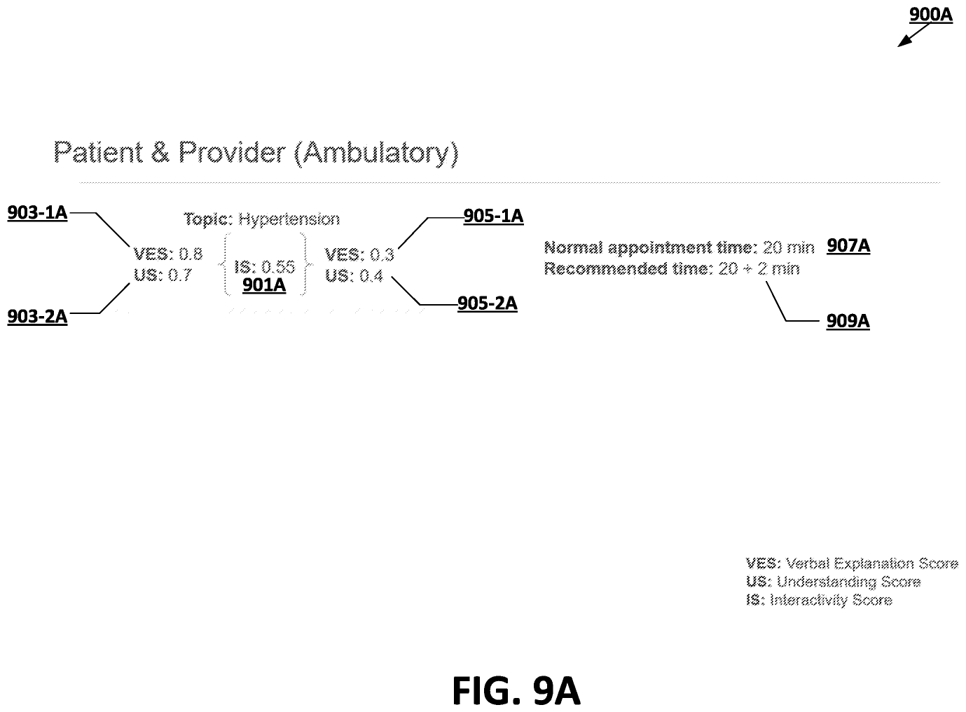

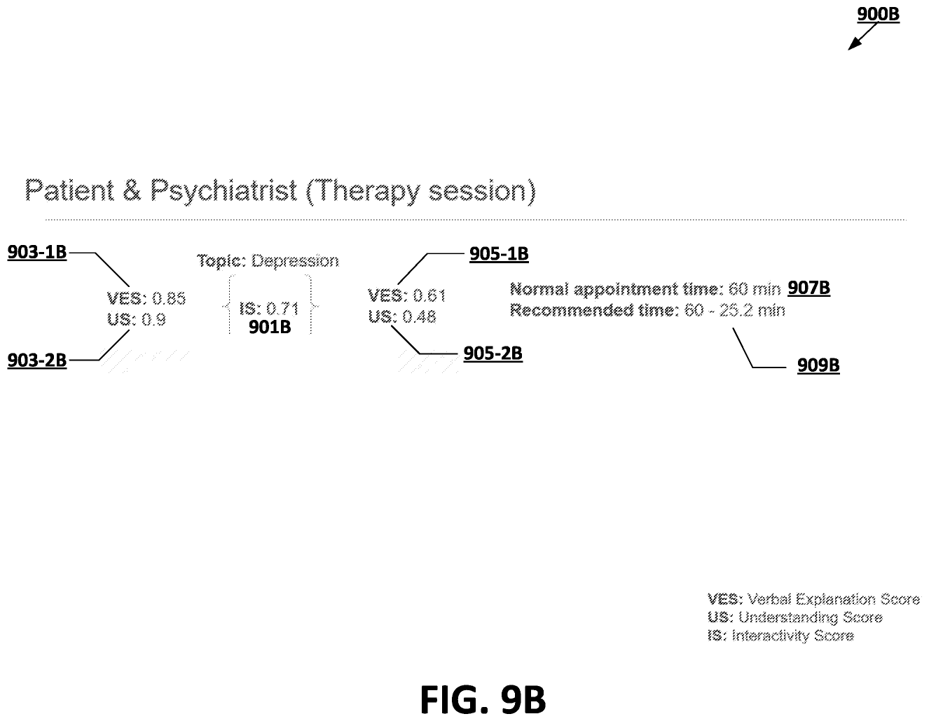

Referring now to FIG. 9A, an operational example 900A depicting generating an optimized appointment prediction in accordance in accordance with some embodiments discussed herein is provided.

As depicted in FIG. 9A, optimized appointment prediction system 101 generates a predicted interactivity measure 901A. As shown, the predicted interactivity measure 901A is based at least in part on a provider verbal explanation measure 903-1A, a provider understanding measure 903-2A, a recipient verbal explanation measure 905-1A, and a recipient understanding measure 905-2A. Additionally, optimized appointment prediction system 101 determines an optimal event time modification value 909A based at least in part on the predicted interactivity measure 901A and with respect to a base time period 907A that is associated with a prospective event or interaction.

Referring now to FIG. 9B, another operational example 900B depicting generating an optimized appointment prediction in accordance in accordance with some embodiments discussed herein is provided is provided.

As depicted in FIG. 9B, optimized appointment prediction system 101 generates a predicted interactivity measure 901B. As shown, the predicted interactivity measure 901B is based at least in part on a provider verbal explanation measure 903-1B, a provider understanding measure 903-2B, a recipient verbal explanation measure 905-1B, and a recipient understanding measure 905-2B. Additionally, optimized appointment prediction system 101 determines an optimal event time modification value 909B based at least in part on the predicted interactivity measure 901B and with respect to a base time period 907B that is associated with a prospective event or interaction.

As discussed herein, the steps/operations of the optimized appointment prediction system 101 may lead to performing one or more optimized scheduling operations. For example, the optimized appointment prediction system 101 may generate one or more outputs (e.g., optimized appointment predictions) and provide (e.g., send, transmit, and/or the like) the outputs to one or more client computing entities 102 for generating user interface data and/or dynamically updating a user interface.

Other examples of optimized scheduling operations include automatically scheduling appointments and automatically generating/triggering appointment notifications. In some embodiments, performing optimized scheduling operations includes automated system load balancing operations and/or automated staff allocation management operations. For example, the optimized appointment prediction system 101 may automatically and/or dynamically process a plurality of event data objects in order to generate optimized appointment predictions for a plurality of patients requiring appointments with one or more providers. As another example, the optimized appointment prediction system 101 may account for patient and/or provider availability on particular days and at particular times. In another example, the optimized appointment prediction system 101 may reassign patients on a schedule in response to receiving real-time information, such as an instance in which a provider is suddenly unavailable due to an emergency or unplanned event/occurrence. Additionally, in some embodiments, the optimized appointment prediction system 101 may be used in conjunction with an Electronic Health Record (EHR) system that is accessible by patients and providers to recommend a particular provider and/or automatically schedule an appointment with a particular provider in response to a request initiated by a patient. In some embodiments, the optimized appointment prediction system 101 may aggregate a plurality of requests (e.g., from patients and/or providers) and generate one or more schedules in response to determining that a threshold number of requests have been received.

In another example, performing optimized scheduling operations includes providing additional appointment information/data (e.g., travel information, medication information, provider information, patient information and/or the like). By way of example, the optimized appointment prediction system 101 may automatically provide pre-generated travel directions for navigating to and returning from an appointment location based at least in part on expected travel patterns at an expected end-time of the appointment. In some embodiments, the pre-generated travel directions may be based at least in part on analysis of travel patterns associated with a plurality of patients that have had appointments with a particular provider and/or at a particular location within a predefined time period.

In some embodiments, performing the optimized scheduling operations includes performing system load balancing operations for a medical record keeping system. For example, upon detecting that a medical appointment takes x minutes, computing resources of a medical record keeping system may be reassigned to ensure that adequate resources are available in order to facilitate medical record keeping as well as retrieval of data during the medical visit. In some embodiments, performing the optimized scheduling operations includes detecting that an appointment ends at a particular time, and provide optimal driving directions for post-appointment trip given expected traffic conditions at the particular time.

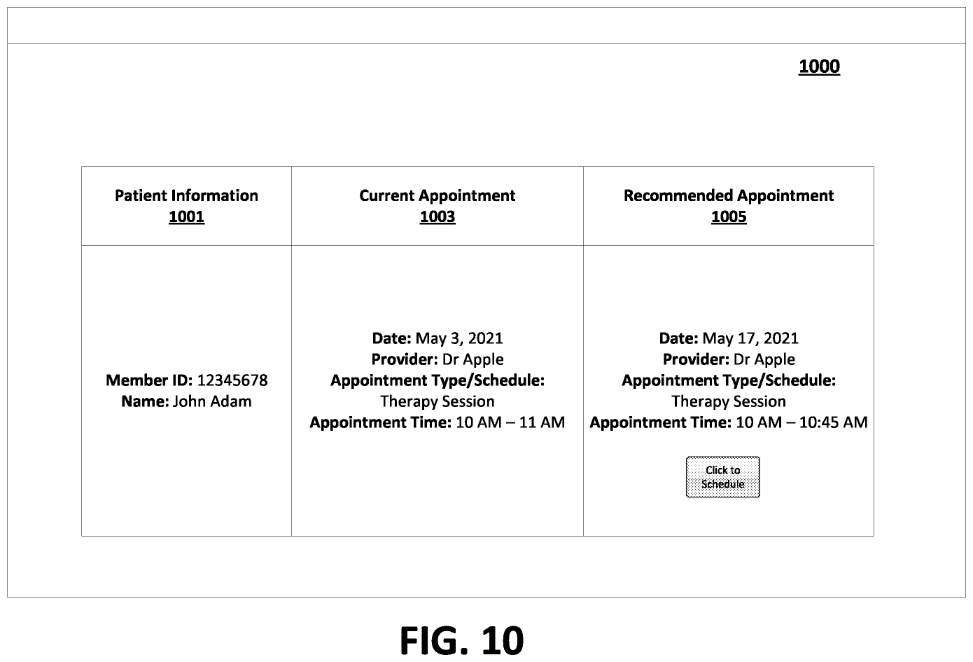

FIG. 10 provides an operational example of a user interface 1000 that is generated based at least in part on dynamically updating user interface data, where the dynamically updating user interface data may be generated based at least in part on an optimal event time modification value and/or optimized appointment prediction. In various embodiments, the client computing entity 102 generates user interface data (e.g., one or more data objects) which is provided (e.g., transmitted, sent and/or the like) for presentation by the user interface 1000 of a user computing entity and/or client computing entity 102. The user interface 1000 may comprise various features and functionality for accessing, and/or viewing data objects and/or alerts. The user interface 1000 may also comprise messages in the form of banners, headers, notifications, and/or the like.

As illustrated in FIG. 10, an example user interface 1000 may receive user interface data for presentation based at least in part on an optimal event time modification value and/or optimized appointment prediction. As shown, the user interface data comprises an indication of patient information 1001, current appointment information 1003 and recommended appointment information 1005 associated with a recipient entity. As depicted, the recommended appointment information 1005 comprises a prospective date, a provider, an event/interaction type and an appointment time.

Thus, as described above, various embodiments of the present invention address technical challenges related to reducing operational load of event scheduling systems and improving computational efficiency of the noted event scheduling systems. For example, as described herein, various embodiments of the present invention enable optimized appointment time predictions that allocate optimized appointment times based at least in part on predicted interaction scores for proposed appointments/interactions, which in turn reduces the need for scheduling follow-up appointments, thus reducing operational load of event scheduling systems and improving computational efficiency of the noted event scheduling systems.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for performing one or more optimized scheduling operations with respect to an event data object, the computer-implemented method comprising:
identifying, by one or more processors, a base time period and an upper bound extension time period for the event data object;
determining, by the one or more processors, a predicted interactivity measure for the event data object;
determining, by the one or more processors and using an optimal event time prediction machine learning model, an optimal event time modification value for the event data object, wherein the optimal event time prediction machine learning model is configured to generate the optimal event time modification value based at least in part on the base time period, the upper bound extension time period, and the predicted interactivity measure;
determining, by one or more processors, an optimized appointment prediction based at least in part on the optimal event time modification value; and
performing, by the one or more processors, the one or more optimized scheduling operations based at least in part on the optimized appointment prediction.

2. The computer-implemented method of claim 1, wherein the optimal event time prediction machine learning model is configured to generate a minimal value for the optimal event time modification value when the predicted interactivity measure has a medial value.

3. The computer-implemented method of claim 1, wherein:
the optimal event time prediction machine learning model comprises a first sub-model that is configured to determine the predicted interactivity measure and a second sub-model that is configured to determine the base time period and the upper bound extension time period, and
the first sub-model generates an output having a minimal value when the predicted interactivity measure has a medial value.

4. The computer-implemented method of claim 1, further comprising:
in an instance in which the optimal event time modification value satisfies a threshold deviation measure, triggering, by the one or more processors, one or more secondary analysis operations for the event data object.

5. The computer-implemented method of claim 1, wherein determining the predicted interactivity measure comprises:
identifying a recipient profile and a provider profile for the event data object;
determining a recipient verbal explanation measure for the recipient profile;
determining a provider verbal explanation measure for the provider profile; and
determining the predicted interactivity measure based at least in part on the recipient verbal explanation measure and the provider verbal explanation measure.

6. The computer-implemented method of claim 5, wherein determining the recipient verbal explanation measure comprises:
determining a recipient verbosity measure and a recipient effectiveness measure for the recipient profile; and
determining the recipient verbal explanation measure based at least in part on the recipient verbosity measure and the recipient effectiveness measure.

7. The computer-implemented method of claim 5, wherein determining the provider verbal explanation measure comprises:
determining a provider verbosity measure and a provider effectiveness measure for the provider profile; and
determining the provider verbal explanation measure based at least in part on the provider verbosity measure and the provider effectiveness measure.

8. An apparatus for performing one or more optimized scheduling operations with respect to an event data object, the apparatus comprising at least one processor and at least one memory including program code, the at least one memory and the program code configured to, with the processor, cause the apparatus to at least:
identify a base time period and an upper bound extension time period for the event data object;
determine a predicted interactivity measure for the event data object;
determine, using an optimal event time prediction machine learning model, an optimal event time modification value for the event data object, wherein the optimal event time prediction machine learning model is configured to generate the optimal event time modification value based at least in part on the base time period, the upper bound extension time period, and the predicted interactivity measure;
determine an optimized appointment prediction based at least in part on the optimal event time modification value; and
perform the one or more optimized scheduling operations based at least in part on the optimized appointment prediction.

9. The apparatus of claim 8, wherein the optimal event time prediction machine learning model is configured to generate a minimal value for the optimal event time modification value when the predicted interactivity measure has a medial value.

10. The apparatus of claim 8, wherein:
the optimal event time prediction machine learning model comprises a first sub-model that is configured to determine the predicted interactivity measure and a second sub-model that is configured to determine the base time period and the upper bound extension time period, and
the first sub-model generates an output having a minimal value when the predicted interactivity measure has a medial value.

11. The apparatus of claim 8, wherein the program code is further configured to, with the processor, cause the apparatus at least to:
in an instance in which the optimal event time modification value satisfies a threshold deviation measure, trigger one or more secondary analysis operations for the event data object.

12. The apparatus of claim 8, wherein the program code is further configured to, with the processor, cause the apparatus to:
determine the predicted interactivity measure by:
identifying a recipient profile and a provider profile for the event data object;
determining a recipient verbal explanation measure for the recipient profile;
determining a provider verbal explanation measure for the provider profile; and
determining the predicted interactivity measure based at least in part on the recipient verbal explanation measure and the provider verbal explanation measure.

13. The apparatus of claim 12, wherein the program code is further configured to, with the processor, cause the apparatus to:
determine the recipient verbal explanation measure by:
determining a recipient verbosity measure and a recipient effectiveness measure for the recipient profile; and
determining the recipient verbal explanation measure based at least in part on the recipient verbosity measure and the recipient effectiveness measure.

14. The apparatus of claim 12, wherein the program code is further configured to, with the processor, cause the apparatus to:
determine the provider verbal explanation measure by:
determining a provider verbosity measure and a provider effectiveness measure for the provider profile; and
determining the provider verbal explanation measure based at least in part on the provider verbosity measure and the provider effectiveness measure.

15. A computer program product for performing one or more optimized scheduling operations with respect to an event data object, the computer program product comprising at least one non-transitory computer-readable storage medium having computer-readable program code portions stored therein, the computer-readable program code portions configured to:
identify a base time period and an upper bound extension time period for the event data object;
determine a predicted interactivity measure for the event data object;
determine, using an optimal event time prediction machine learning model, an optimal event time modification value for the event data object, wherein the optimal event time prediction machine learning model is configured to generate the optimal event time modification value based at least in part on the base time period, the upper bound extension time period, and the predicted interactivity measure;
determine an optimized appointment prediction based at least in part on the optimal event time modification value; and
perform the one or more optimized scheduling operations based at least in part on the optimized appointment prediction.

16. The computer program product of claim 15, wherein the optimal event time prediction machine learning model is configured to generate a minimal value for the optimal event time modification value when the predicted interactivity measure has a medial value.

17. The computer program product of claim 15, wherein:
the optimal event time prediction machine learning model comprises a first sub-model that is configured to determine the predicted interactivity measure and a second sub-model that is configured to determine the base time period and the upper bound extension time period, and
the first sub-model generates an output having a minimal value when the predicted interactivity measure has a medial value.

18. The computer program product of claim 15, wherein the computer-readable program code portions are further configured to:
in an instance in which the optimal event time modification value satisfies a threshold deviation measure, trigger one or more secondary analysis operations for the event data object.

19. The computer program product of claim 15, wherein the computer-readable program code portions are further configured to:
determine the predicted interactivity measure by:
identifying a recipient profile and a provider profile for the event data object;
determining a recipient verbal explanation measure for the recipient profile;
determining a provider verbal explanation measure for the provider profile; and
determining the predicted interactivity measure based at least in part on the recipient verbal explanation measure and the provider verbal explanation measure.

20. The computer program product of claim 19, wherein the computer-readable program code portions are further configured to:
determine the recipient verbal explanation measure by:
determining a recipient verbosity measure and a recipient effectiveness measure for the recipient profile; and
determining the recipient verbal explanation measure based at least in part on the recipient verbosity measure and the recipient effectiveness measure.
